(19) United States
(12) Patent Application Publication
(10) Pub. No.: US 2009/0303720 A1
(43) Pub. Date: Dec. 10, 2009

(54) LED Lighting Device

(75) Inventor: William R. McGrath, Randolph, VT (US)

Correspondence Address: DOWNS RACHLIN MARTIN PLLC, 199 MAIN STREET, P O BOX 190, BURLINGTON, VT, 05402-0190, US

(73) Assignee: LEDDYNAMICS, INC., Randolph, VT (US)

(21) Appl. No.: 12/534,580

(22) Filed: Aug. 3, 2009

Related U.S. Application Data
(63) Continuation of application No. 11/361,656, filed on Feb. 23, 2006, now abandoned.
(60) Provisional application No. 60/657,100, filed on Feb. 28, 2005.

(51) Int. Cl. F21S 4/00

(52) U.S. Cl. 362/249.02

(57) ABSTRACT

An arrangement of a multiplicity of LEDs, drive circuitry, and supporting structure to form a replacement for standard fluorescent tubes without the need to rewire or remove the magnetic or electronic ballasts in use in standard fluorescent fixtures.

### RELATED APPLICATION DATA

This application is a continuation application of U.S. patent application Ser. No. 11/361,656, filed Feb. 23, 2006 entitled “Circuit Devices Which Include Light Emitting Diodes, Assemblies Which Include Such Circuit Devices, and Methods for Directly Replacing Fluorescent Tubes,” which is incorporated herein by reference in its entirety. This application claims the benefit and priority of U.S Provisional Application Ser. No. 60/657,100 filed Feb. 28, 2005 entitled “Fluorescent Replacement Using Light Emitting Diodes,” which is incorporated herein by reference in its entirety.

### FIELD OF THE INVENTION

The present invention relates to a circuit device for providing energy to a series of light emitting diodes and an assembly including such circuit devices and light emitting diodes. The present invention relates to a light emitting diode (LED) assembly for direct replacement of a tubular fluorescent light bulb.

### BACKGROUND

The widespead use of fluorescent tubes for general purpose lighting has several drawbacks. One significant drawback is their use of rare-earth and other toxic phosphors to generate light. This provides a problem when tubes which have ceased to function require disposal. The phosphors can present a toxic waste situation which must be dealt with. Also, because the envelope of the tube is thin glass, the potential for accidental breakage, with attendant problems of scattering toxic material, is high. For this reason, in food-related and other industries where potential contamination is a risk, special plastic protective sleeves are required to be placed on all fluorescent tubes. A drawback to the use of these sleeves is that they trap heat generated by the tube and increase the operating temperature of the tube which decreases the useful life of the device.

The ballasts used in fluorescent fixtures present an inductive load to the line resulting in a lower than unity power factor. While fluorescent lighting is longer lasting and more efficient than incandescent bulbs, the tubes have a short life relative to solid state lighting devices. Based on an eight hour per day use, LED lighting will have an average usable life ten times that of a fluorescent light source.

With the introduction of high current, high output LEDs, the use of these devices in general purpose lighting has become feasible. One area of general lighting which could benefit from this technology is fluorescent lighting. Heretofore, tubes meant to accomplish this were unable to work with standard magnetic or electronic ballasts, and required replacement or complete rewiring of the lighting fixture.

### SUMMARY OF THE DISCLOSURE

In one implementation, an LED lighting device for replacing a fluorescent tube in a fluorescent lighting fixture having fluorescent fixture connectors and one or more of a standard fluorescent ballast and a magnetic fluorescent ballast is provided. The LED lighting device includes a plurality of light emitting diodes; a pair of contact pins at each end of the lighting device, said contact pins configured for mating with the fluorescent fixture connectors of the fluorescent lighting fixture; and drive circuitry connected with said plurality of light emitting diodes and at least one contact pin of said pair of contact pins, said drive circuitry configured to provide an operating current to said plurality of light emitting diodes and to operate with a standard fluorescent ballast and a magnetic fluorescent ballast such that the lighting device is operable when connected to a fluorescent lighting fixture having a standard fluorescent ballast and operable when connected to a fluorescent lighting fixture having a magnetic fluorescent ballast.

In another implementation, an LED lighting device is provided. The LED lighting device includes a plurality of light emitting diodes; a pair of end caps, each of said pair of end caps disposed at an end of the lighting device; a male bi-pin fluorescent fixture connector disposed on each of said pair of end caps, each male bi-pin fluorescent fixture connector configured to mate with a fluorescent fixture connector of a fluorescent fixture having a standard electronic fluorescent ballast and to mate with a fluorescent fixture connector of a fluorescent fixture having a magnetic fluorescent ballast; and drive circuitry connected with at least one contact pin of said male bi-pin fluorescent fixture connectors and said plurality of light emitting diodes, said drive circuitry configured to provide an operating current to said plurality of light emitting diodes when said at least one contact pin is connected to a fluorescent fixture having a standard electronic fluorescent ballast and to provide an operating current to said plurality of light emitting diodes when said at least one contact pin is connected to a fluorescent fixture having a magnetic fluorescent ballast.

In yet another implementation, an LED lighting device is provided. The LED lighting device includes a pair of end caps, each of said pair of end caps disposed at an end of the lighting device; a housing extending between said pair of end caps; a plurality of light emitting diodes arranged in a single row between said pair of end caps, said housing comprising a plurality of fins extending radially outward from three sides of said plurality of light emitting diodes; a male bi-pin fluorescent fixture connector disposed on each of said pair of end caps, each male bi-pin fluorescent fixture connector configured to mate with a fluorescent fixture connector of a fluorescent fixture having a standard fluorescent ballast and to mate with a fluorescent fixture connector of a fluorescent fixture having a magnetic fluorescent ballast; and drive circuitry connected with at least one contact pin of said male bi-pin fluorescent fixture connectors and said plurality of light emitting diodes, said drive circuitry configured to provide an operating current to said plurality of light emitting diodes when said at least one contact pin is connected to a fluorescent fixture having a standard fluorescent ballast and to provide an operating current to said plurality of light emitting diodes when said at least one contact pin is connected to a fluorescent fixture having a magnetic fluorescent ballast.

In still another implementation, a circuit arrangement is provided. The circuit arrangement provides the proper drive to a multiplicity of LEDs, connected in a series string, by deriving the drive from standard magnetic or electronic ballast and commonly used fluorescent fixture wiring. Another circuit provides the capability of operation with any fixture wiring variation. Yet another circuit provides protection against the ballast generating a high “strike” voltage in the event that an LED fails open. Still another embodiment is shown which provides dimming capability for the light. Still yet another embodiment shows the interface circuitry for remotely dimming the LED light.

In yet still another implementation, no glass or other easily breakable materials are utilized and no toxic substances are used. Therefore, there is no need for heat trapping protective sleeves or other covering devices to be used. A further implementation provides for means to remove the heat generated by the LEDs and thereby increase the useful life of the devices. In still a further implementation, the filter capacitance at the input offsets, to some degree, the inductive load presented by the ballast and bring the input power factor closer to unity.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a plan view of the final assembly of an embodiment of the invention.

FIG. 2 is a cross-sectional view of one end-cap of the assembly.

FIG. 3 is a cross-sectional view of the LED mounting and heat sink.

FIG. 4 is a schematic diagram of a basic embodiment of circuit elements and LEDs

FIG. 5 is a schematic diagram of an embodiment providing an arrangement of circuit elements to accommodate differing versions of fixture wiring.

FIG. 6 is a schematic diagram of a circuit which protects the circuit elements against damage from ballast-generated, high voltage “strike” voltages.

FIG. 7 is a schematic diagram of an embodiment providing dimming capability.

FIG. 8 is a schematic diagram of an embodiment providing interface circuitry for remote dimming of the device.

### REFERENCE NUMERALS IN THE DRAWINGS

10 Contact Pin

20 End Cap

30 Heat Sink

40 Bridge Rectifier

45 Bus Wire

50 Input Capacitor

55 Input Circuit Board

60 LED

70 LED Circuit Board

90 Thermally Conductive Isolator

100 Shut Down Triac

110 Overvoltage Sense Zener Diode

120 Current Setting Resistor

125 Control Circuit Board

130 NPN Power Transistor

140 Base Drive Resistor

150 Diode

200 N Channel MOSFET

210 P Channel MOSFET

220 Microprocessor

240 Voltage Regulator

250 Input Zener Diode

260 Filter Capacitor

270 Capacitor

280 Base Drive Resistor

290 NPN Transistor

300 Diode

310 Resistor

320 NPN Transistor

330 Resistor

340 Diode

350 Resistor

360 PNP Transistor

370 Zener Diode

380 Interface Device

### DETAILED DESCRIPTION

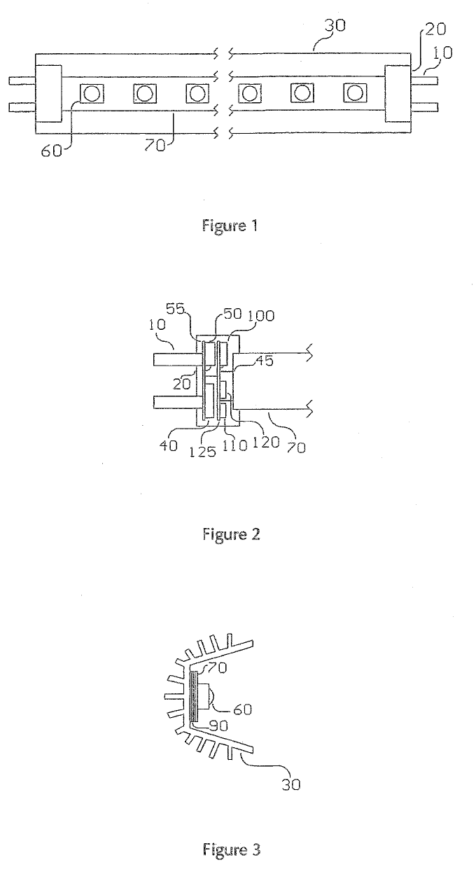

Referring now to the drawings, FIG. 1 shows a plan view of an embodiment of the present invention. A multiplicity of LEDs 60 are mounted to the LED circuit board 70 and attached to two end caps 20. This assembly is mounted to heat sink 30 which also acts as a protective housing. The end caps 20 are fitted with contact pins 10, spaced such that they mate with standard fluorescent fixture connectors. The overall length of the assembly is equivalent to that of a standard fluorescent tube.

FIG. 2 is a cross-sectional of an end cap 20. Contact pins 10 are physically and electrically connected to the input circuit board 55 upon which are mounted the rectifier bridge 40 and capacitor 50. The input circuit board 55 is physically and electrically connected to the control circuit board 125 by bus wires 45. The shut down triac 100, overvoltage sense Zener diode 110, and current setting resistor 120 are mounted on control circuit board 125. These components are from the embodiment shown in FIG. 6 and are used for illustrative purposes only. As would be known to anyone skilled in the art, the components for any of the embodiments shown could be mounted to this board.

FIG. 3 is a cross sectional view of the LED mounting and heat sink. The LEDs 60 are mounted to LED circuit board 70. This assembly is affixed to the heat sink 30 with thermally conductive isolator 90 such as T -Flex 210, manufactured by Thermagon, or other such materials well known to anyone skilled in the art. Heat sink 30 consists of an aluminum extrusion coated with a material such as Powder Coat 10225 manufactured by The Eastman Company or other similar materials well known to anyone skilled in the art. This material, while being highly reflective to visible light has a high emissivity for infra-red. Conversely, the coating used on standard fluorescent fixtures, while being highly reflective to visible light, is an excellent absorber of infra-red. This combination permits heat sink 30 to effectively couple heat generated by the LEDs to the large area of the fluorescent fixture.

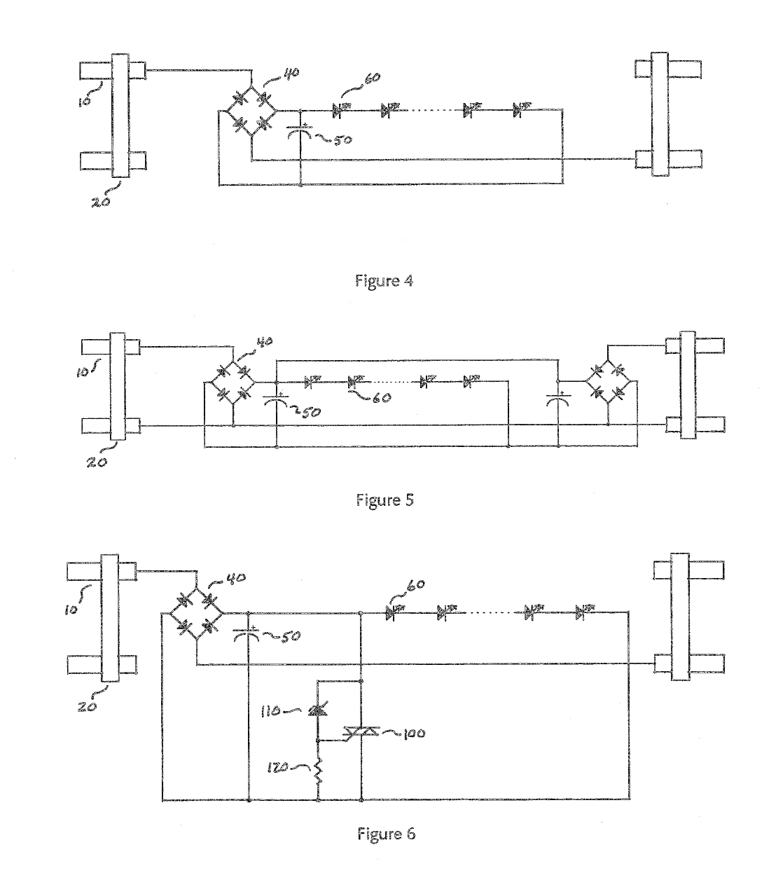

The operation of example LED drive circuits within the present invention will now be described in detail while referencing the embodiments of FIGS. 4 through 8. All of the drive circuits presented herein make use of the constant current characteristic of standard and magnetic ballasts. By choosing LEDs which require a current of this magnitude, the need for additional constant current drive circuitry is eliminated.

FIG. 4 shows one type of drive for the LED string. A multiplicity of LEDs 60 is connected as a series string. The primary AC power is brought to the circuit by contact pins 10. The input voltage is rectified by bridge rectifier 40 and filtered by capacitor 50. The rectified, filtered voltage is then connected to the series string of LEDs 60. The embodiment shown in FIG. 4 will operate with the most common wiring configuration of fluorescent fixtures. FIG. 5 shows the preferred embodiment for input power conditioning. A second bridge rectifier and filter capacitor are added to those shown in FIG. 4. The embodiment of FIG. 5 allows the present invention to operate in any fluorescent fixture wired in accordance with prevailing electrical codes.

Should an LED in the series string fail as an open circuit, the ballast will sense that there is no current flowing and apply a high voltage “strike” voltage. This would normally cause the fluorescent tube to light. A “strike” voltage could cause serious damage to other components. To prevent this, the drive circuit shown in FIG. 6 is used. As shown, shut down triac 100 is connected across the power input to the LEDs 60. If a “strike” voltage occurs, overvoltage sense Zener diode 110 conducts current. At a current set by current setting resistor 120, a voltage sufficient to trigger shut down triac 100 into conduction will appear at its gate terminal. This shunts the voltage across the LED string and prevents possible catastrophic failure of other circuit elements.

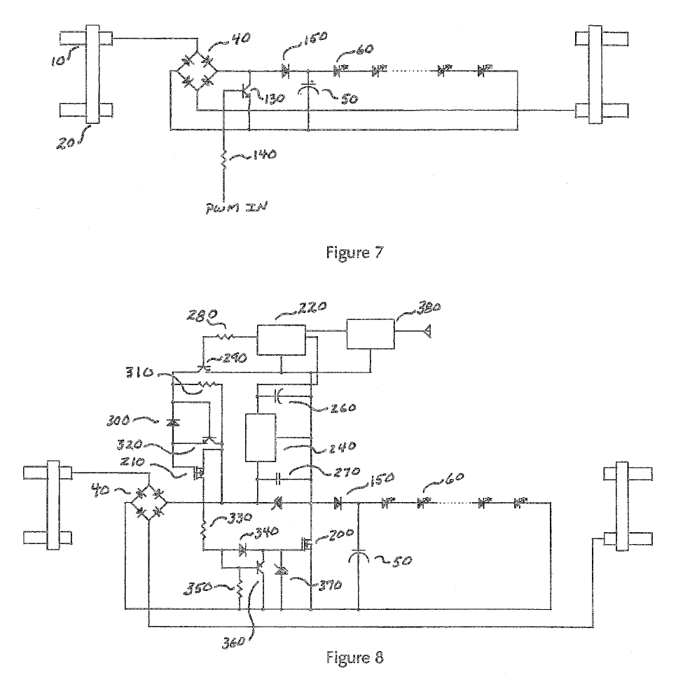

FIG. 7 is the same embodiment shown in FIG. 4 with a dimming capability provided by the addition of an NPN transistor 130, a base drive resistor 140, and diode 150. A pulse width modulated (PWM) signal is applied to the base of NPN transistor 130 through base drive resistor 140. This causes NPN transistor 130 to shunt the drive current to LEDs 60. By switching NPN transistor 130 on and off at a rate sufficiently high to prevent flicker, the apparent brightness of the LEDs 60 will vary as the on to off time ratio of NPN transistor 130 is varied. Diode 150 prevents NPN transistor 130 from discharging capacitor 50.

FIG. 8 shows an embodiment which provides a remotely controlled dimming capability. The interface device 380, which could be an infra-red, rf, or other type of receiver, sends command signals to microprocessor 220. Operating voltage for microprocessor 220 and interface device 380 is provided by a low voltage regulator consisting of input Zener diode 250, voltage regulator 240, filter capacitor 260, and capacitor 270. The output of microprocessor 220 provides a drive signal to a level shifting and gate drive circuit consisting of resistors 280, 310, 330, and 350, NPN transistors 290 and 320, PNP transistor 360, P channel MOSFET 210, diodes 300 and 340, and Zener diode 370. The gate drive signal is applied to N channel MOSFET 200. By switching N channel MOSFET 200 on and off, in the same manner as recited above for NPN transistor 130, the apparent brightness of LEDs 60 can be varied.

It will be apparent to anyone skilled in the art that the embodiment of FIG. 8 could be modified to control two strings of LEDs. By selecting warm white (low color temperature) for one string and cool white (high color temperature) for the other, that by varying the intensity of the strings with relation to each other, the resultant, effective color temperature could be controlled.

Although the description above contains specific heat sink, mounting, and assembly designs, these should not be construed as limiting the scope of the invention but as merely providing an illustration of the currently preferred embodiment.

Further, although various circuit configurations have been shown and described above there are numerous variations which can be used with the present invention, the specific design of which will be evident to one skilled in the art given the detailed description herein.

Thus, although the present invention has been described in relation to particular embodiments therof, many other variations and modifications will become apparent to those skilled in the art. It is preferred, therefore, that the present invention be limited not by the specific disclosure herein, but only by the appended claims.

What is claimed is:

1. An LED lighting device for replacing a fluorescent tube in a fluorescent lighting fixture having fluorescent fixture connectors and one or more of a standard fluorescent ballast and a magnetic fluorescent ballast, the LED lighting device comprising:
a plurality of light emitting diodes;
a pair of contact pins at each end of the lighting device, said contact pins configured for mating with the fluorescent fixture connectors of the fluorescent lighting fixture; and
drive circuitry connected with said plurality of light emitting diodes and at least one contact pin of said pair of contact pins, said drive circuitry configured to provide an operating current to said plurality of light emitting diodes and to operate with a standard fluorescent ballast and a magnetic fluorescent ballast such that the lighting device is operable when connected to a fluorescent lighting fixture having a standard fluorescent ballast and operable when connected to a fluorescent lighting fixture having a magnetic fluorescent ballast.

2. An LED lighting device according to claim 1, wherein each of the plurality of light emitting diodes has a current requirement matched to the current characteristics of a standard fluorescent ballast and the current characteristics of a magnetic fluorescent ballast

3. An LED lighting device according to claim 1, further comprising a pair of end caps, each of said pair of end caps positioned at an end of the lighting device and including said pair of contact pins.

4. An LED lighting device according to claim 3, wherein at least one of said pair of end caps includes a circuit board.

5. An LED lighting device according to claim 4, wherein at least a portion of said drive circuitry is mounted to said circuit board.

6. An LED lighting device according to claim 5, wherein said drive circuitry comprises a shut down triac, an overvoltage sense Zener diode, and a current setting resistor mounted to said circuit board.

7. An LED lighting device according to claim 3, wherein at least one of said pair of end caps includes an input circuit board having a rectifier bridge and a capacitor.

8. An LED lighting device according to claim 7, further comprising a control circuit board inside at least one of said pair of end caps, said control circuit board having thereon at least a portion of said drive circuitry.

9. An LED lighting device according to claim 1, wherein said drive circuitry is electrically connected to all contact pins of each said pair of contact pins.

10. An LED lighting device according to claim 1, further comprising a protective housing that is a heat sink for the plurality of light emitting diodes.

11. An LED lighting device comprising:
a plurality of light emitting diodes;
a pair of end caps, each of said pair of end caps disposed at an end of the lighting device;
a male bi-pin fluorescent fixture connector disposed on each of said pair of end caps, each male bi-pin fluorescent fixture connector configured to mate with a fluorescent fixture connector of a fluorescent fixture having a standard electronic fluorescent ballast and to mate with a fluorescent fixture connector of a fluorescent fixture having a magnetic fluorescent ballast; and
drive circuitry connected with at least one contact pin of said male bi-pin fluorescent fixture connectors and said plurality of light emitting diodes, said drive circuitry configured to provide an operating current to said plurality of light emitting diodes when said at least one contact pin is connected to a fluorescent fixture having a standard electronic fluorescent ballast and to provide an operating current to said plurality of light emitting diodes when said at least one contact pin is connected to a fluorescent fixture having a magnetic fluorescent ballast.

12. An LED lighting device according to claim 11, wherein said drive circuitry is located in at least one of said pair of end caps.

13. An LED lighting device according to claim 11, wherein said drive circuitry is electrically connected with all contact pins of said male bi-pin fluorescent fixture connectors.

14. An LED lighting device according to claim 11, further comprising a protective housing that is a heat sink for the plurality of light emitting diodes.

15. An LED lighting device according to claim 11, further comprising a protective housing having a cross-section that encloses said plurality of light emitting diodes on three sides and having a plurality of fins extending from each of said three sides.

16. An LED lighting device according to claim 11, wherein said plurality of light emitting diodes are arranged longitudinally along said lighting device in a single row between said pair of end caps.

17. An LED lighting device according to claim 16, further comprising an outer housing that includes a plurality of fins, said outer housing enclosing said plurality of light emitting diodes on three sides and said plurality of fins extending radially from each of said three sides.

18. An LED lighting device comprising:
a pair of end caps, each of said pair of end caps disposed at an end of the lighting device;
a housing extending between said pair of end caps;
a plurality of light emitting diodes arranged in a single row between said pair of end caps, said housing comprising a plurality of fins extending radially outward from three sides of said plurality of light emitting diodes;
a male bi-pin fluorescent fixture connector disposed on each of said pair of end caps, each male bi-pin fluorescent fixture connector configured to mate with a fluorescent fixture connector of a fluorescent fixture having a standard fluorescent ballast and to mate with a fluorescent fixture connector of a fluorescent fixture having a magnetic fluorescent ballast; and
drive circuitry connected with at least one contact pin of said male bi-pin fluorescent fixture connectors and said plurality of light emitting diodes, said drive circuitry configured to provide an operating current to said plurality of light emitting diodes when said at least one contact pin is connected to a fluorescent fixture having a standard fluorescent ballast and to provide an operating current to said plurality of light emitting diodes when said at least one contact pin is connected to a fluorescent fixture having a magnetic fluorescent ballast.

19. An LED lighting device according to claim 18, wherein said drive circuitry is located in at least one of said pair of end caps.

20. An LED lighting device according to claim 18, wherein said drive circuitry is electrically connected with all contact pins of said male bi-pin fluorescent fixture connectors.
